(19) United States
(12) Patent Application Publication
(10) Pub. No.: US 2008/0206565 A1
(43) Pub. Date: Aug. 28, 2008

(54) NANO-PARTICLE LIGHT EMITTING MATERIAL, ELECTRIC FIELD LIGHT EMITTING DIODE AND INK COMPOSITION EACH USING THE MATERIAL, AND DISPLAY APPARATUS

(75) Inventors: Masahiko Takahashi, Hachioji-shi (JP); Sotomitsu Ikeda, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/034,712

(22) Filed: Feb. 21, 2008

(30) Foreign Application Priority Data
Feb. 28, 2007 (JP) 2007-049149

(51) Int. Cl. C09K 11/88; C09D 11/00; B32B 9/00; B32B 5/16

(52) U.S. Cl. 428/403; 428/690; 106/31.13

(57) ABSTRACT

An object of the present invention is to provide a nano-particle light emitting material having a specific ligand and an electric field light emitting diode having high light emitting efficiency. The nano-particle light emitting material includes: a core portion formed of a nano-particle; and a shell portion formed of at least two kinds of ligands localized on a surface of the core portion, in which at least one kind of the ligands includes a hole transportable ligand, and at least one kind of the ligands includes an electron transportable ligand.

### BACKGROUND OF THE INVENTION

1. Field of the Invention

The present invention relates to a nano-particle light emitting material, an electric field light emitting diode and an ink composition each using the material, and a display apparatus.

2. Description of the Related Art

An organic light emitting diode (OLED) is a light emitting diode having such a structure that a thin film formed by laminating layers each formed of, for example, a fluorescent or phosphorescent compound, a hole transportable compound, or an electron transportable compound is interposed between electrodes. In the OLED, a voltage is applied between the electrodes. As a result, an electron and a hole are injected into the organic thin film to recombine, whereby an exciton of the fluorescent or phosphorescent compound is produced. Light is emitted when the exciton returns to its ground state.

The OLED has the following characteristics: the OLED can be driven at a low voltage, emits light with high efficiency, responds at a high speed, is of a self-light-emitting type, has an unlimited view angle, shows a wide variety of light emitting wavelengths, and has a light weight. Accordingly, the OLED is expected to serve as a next-generation light emitting device in a wide variety of fields including a thin display and a lighting unit.

By the way, nano-particles each having a size of about several nanometers to twenty nanometers have been attracting attention in recent years because of their potential to serve as light emitting materials for the OLED. For example, CdSe nano-particles are light emitting materials having the following characteristics: the nano-particles each have higher durability and a narrower spectral bandwidth than those of an organic light emitter, and the luminescent colors of the nano-particles, which are formed of the same material, can be controlled depending on the particle diameters of the nano-particles. Further, each of the CdSe nano-particles is of a core-shell structure such as a CdSe/ZnS structure, whereby a packing effect on the defects of the surfaces of the nano-particles and an internal quantum confinement effect increase, and a high internal quantum efficiency in excess of 50% is realized. The use of such nano-particles is expected to realize a device which: exerts physical and chemical properties that are not observed in a bulk particle; and has characteristics comparable to or higher than those of a conventional device.

In addition, the outermost surface of each of the nano-particles is coated with an organic ligand, so the nano-particles can be dispersed in an organic solvent without the agglomeration of the nano-particles. Accordingly, in a production process for an electric field light emitting diode, a film can be formed by applying the solution, and the nano-particles can be expected to correspond to a low-cost, large-area light emitting device.

Several reports on a quantum dot electric field light emitting diode (QDLED) using nano-particles as light emitting materials have been heretofore made. For example, an electric field light emitting diode having an extremely narrow spectral bandwidth around 30 nm has been realized by a simple process based on the application of a solution containing CdSe/ZnS nano-particles (see, for example, Nature, 2002, Vol. 420, p. 800). However, QDLED's that have been heretofore reported each involve, for example, the following problem: each of the QDLED's has light emitting efficiency one or more orders of magnitude lower than that of a conventional OLED.

One possible cause for the low light emitting efficiency of each of the QDLED's is the presence of an organic ligand with which a nano-particle surface is coated. An organic ligand to be generally used in a nano-particle is, for example, tri-n-octylphosphine oxide (TOPO). Such ligand has the following effect: the ligand coordinates to a nano-particle surface, whereby nano-particles can be prevented from agglomerating, and can be stably dispersed in a solution. However, such ligand is basically free of a charge transporting function, so the ligand may be an obstacle upon injection of charge (an electron and a hole) into each nano-particle in a QDLED.

In view of the foregoing, with a view to improving the light emitting efficiency of a QDLED, attempts have been made to impart a charge transporting function to an organic ligand with which a nano-particle surface is coated (see, for example, Japanese Patent Application Laid-Open No. 2004-315661 and Adv. Mater., 2003, 15, No. 1, p. 58).

In each of Japanese Patent Application Laid-Open No. 2004-315661 and Adv. Mater., 2003, 15, No. 1, p. 58, a charge transporting function at the ligand portion of a nano-particle surface is improved, but no such active contrivance that charge is efficiently injected into a nano-particle has been made. In addition, Japanese Patent Application Laid-Open No. 2004-315661 describes that the current-voltage characteristics of a QDLED are improved, but does not describe that the light emitting efficiency of the QDLED is improved. Merely imparting a charge transporting function to a ligand on a nano-particle surface may involve the following problem: charge injected into a light emitting layer is not injected into any nano-particle, and passes through only a ligand portion to flow in an electrode in some cases, so sufficient light emitting efficiency cannot be obtained. Accordingly, the mere impartment of a charge transporting function to a ligand portion does not suffice for an improvement in light emitting efficiency of a QDLED. The ligand portion must be provided with such a function that the injection of charge into a nano-particle, the confinement of charge in the nano-particle, and recombination between a hole and an electron can be efficiently performed as well as the charge transporting function.

### SUMMARY OF THE INVENTION

An object of the present invention is to provide a nano-particle light emitting material having a specific ligand. Another object of the present invention is to provide an electric field light emitting diode having high light emitting efficiency.

The present invention provides a nano-particle light emitting material, including: a core portion formed of a nano-particle; and a shell portion formed of at least two kinds of ligands localized on a surface of the core portion, in which at least one kind of the ligands comprises a hole transportable ligand, and at least one kind of the ligands comprises an electron transportable ligand.

According to the present invention, there can be provided a nano-particle light emitting material having a specific ligand, and an electric field light emitting diode having high light emitting efficiency.

In addition, in the nano-particle light emitting material of the present invention, both a ligand having an electron transporting function and a ligand having a hole transporting function are coordinated to a nano-particle surface, so charge transport between the ligands is suppressed, and the efficiency with which charge is injected into a nano-particle is improved. Further, the nano-particle light emitting material of the present invention has a suppressing effect on the transport of charge once injected into a nano-particle to the outside of the nano-particle, so the probability that an electron and a hole recombine in the nano-particle increases.

Further, the light emitting efficiency of the nano-particle light emitting material of the present invention can be additionally improved by the optimization of the ligands of the material.

Further features of the present invention will become apparent from the following description of exemplary embodiments with reference to the attached drawings.

### BRIEF DESCRIPTION OF THE DRAWINGS

FIG. 1 is a schematic view showing a nano-particle light emitting material of the present invention.

FIG. 2 is an energy level diagram showing a relationship between a ligand and a nano-particle as a condition for an improvement in efficiency with which charge is injected into the nano-particle.

FIG. 3 is a schematic view showing the principle on which a charge confinement effect in the nano-particle light emitting material of the present invention is improved.

FIG. 4 is an energy level diagram showing a relationship between a ligand and a nano-particle as a condition for an improvement in charge confinement effect of the nano-particle.

FIG. 5 is an energy level diagram showing a relationship between a ligand and a core-shell type nano-particle as a condition for an improvement in charge confinement effect of the nano-particle.

FIG. 6 is a sectional view showing an embodiment of an electric field light emitting diode of the present invention.

### DESCRIPTION OF THE EMBODIMENTS

First, a nano-particle light emitting material of the present invention will be described.

The nano-particle light emitting material of the present invention is formed of: a core portion formed of a nano-particle; and a shell portion formed of at least two kinds of ligands localized on the surface of the core portion. At least one kind of those ligands is a hole transportable ligand, and at least one kind of the ligands is an electron transportable ligand.

Hereinafter, the nano-particle light emitting material of the present invention will be described with reference to drawings.

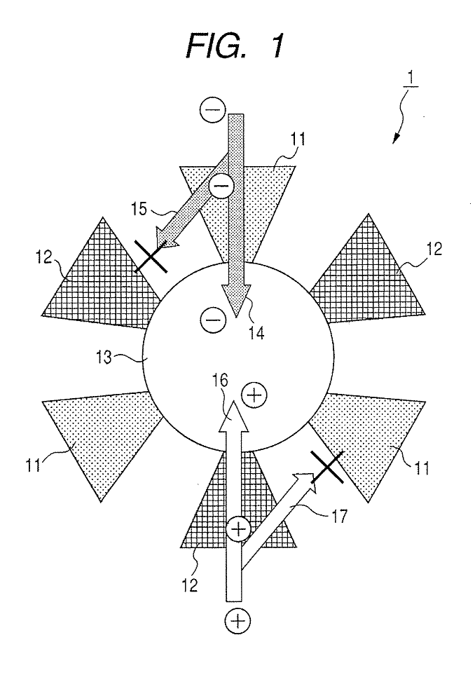

First, reference numerals shown in FIGS. 1 to 6 will be described.

Reference numeral 1 represents a nano-particle light emitting material. Reference numerals 11 and 31 each represent an electron transportable ligand. Reference numerals 12 and 32 each represent a hole transportable ligand.

Reference numerals 13 and 33 each represent a nano-particle. Reference numerals 14 and 34 each represent electron injection from an electron transportable ligand to a nano-particle.

Reference numeral 15 represents an electron transfer path between ligands.

Reference numerals 16 and 36 each represent hole injection from a hole transportable ligand to a nano-particle.

Reference numeral 17 represents a hole transfer path between ligands.

Reference numerals 22, 42, and 52 each represent the energy band of an electron transportable ligand. Reference numerals 21, 41, and 51 each represent the energy band of a hole transportable ligand. Reference numerals 23, 43, and 53 each represent the energy band of a nano-particle.

Reference numerals 24, 46, and 57 each represent the HOMO level of an electron transportable ligand. Reference numeral 25 represents the HOMO level of a hole transportable ligand.

Reference numerals 26, 44, and 54 each represent the LUMO level of a hole transportable ligand. Reference numeral 27 represents the LUMO level of an electron transportable ligand. Reference numeral 35 represents the movement of an electron from a nano-particle to the outside of the nano-particle. Reference numeral 37 represents the movement of a hole from a nano-particle to the outside of the nano-particle. Reference numeral 45 represents the lowest electron level in the conduction band of a nano-particle. Reference numeral 47 represents the highest electron level in the valence band of the nano-particle. Reference numeral 55 represents the lowest electron level in the conduction band of a core layer. Reference numeral 56 represents the lowest electron level in the conduction band of a shell layer. Reference numeral 58 represents the highest electron level in the valence band of the core layer. Reference numeral 59 represents the highest electron level in the valence band of the shell layer. Reference numeral 50 represents the energy band of the shell layer. Reference numeral 60 represents an electric field light emitting diode, reference numeral 61 represents a substrate, reference numeral 62 represents a transparent electrode, reference numeral 63 represents a hole transporting layer, reference numeral 64 represents a light emitting layer, reference numeral 65 represents an electron transporting layer, reference numeral 66 represents a back electrode, and reference numeral 67 represents a power source.

FIG. 1 is a schematic view showing the nano-particle light emitting material of the present invention. The nano-particle light emitting material 1 shown in FIG. 1 is formed of: a core portion formed of the nano-particle 13; and a shell portion formed of the electron transportable ligands 11 and the hole transportable ligands 12. In the nano-particle light emitting material 1 shown in FIG. 1, the electron transportable ligands 11 and the hole transportable ligands 12 are localized on the surface of the nano-particle 13 by an intermolecular attractive force. Here, examples of the intermolecular attractive force include a covalent bond, a coordinate bond, an electrostatic interaction, an ionic bond, and a hydrogen bond.

As shown in FIG. 1, the electron transportable ligands 11 and the hole transportable ligands 12 localized on the surface of the nano-particle 13 are desirably placed on the nano-particle 13 in such a manner that ligands of the same kind are dispersed without being localized. With such constitution, charge transporting performance possessed by each of the electron transportable ligands 11 and the hole transportable ligands 12 can be effectively exerted.

Next, a member of which the nano-particle light emitting material of the present invention is formed will be described.

The nano-particle 13 serving as the core portion is not particularly limited as long as the nano-particle is a light emitting fine particle, and the nano-particle may be any one of, for example, inorganic matter, organic matter, and a composite of inorganic matter and organic matter. In addition, the nano-particle 13 may be of a monolayer structure, or may be of a multilayer structure such as a core-shell structure. The nano-particle 13 is preferably a fine particle having a core-shell structure. The nano-particle 13 has a particle diameter of 0.1 nm to 1 μm, or preferably 1 nm to 20 nm. The wavelength of light to be emitted from the nano-particle 13 in the nano-particle light emitting material of the present invention is not particularly limited, and an effect of the present invention can be exerted irrespective of whether the wavelength is in an ultraviolet region, a visible region, or an infrared region.

The electron transportable ligands 11 each serving as the shell portion are each formed of a site to be coordinated to the surface of the nano-particle 13 and a site having electron transporting property. The two sites are not needed to be completely separate, and, for example, part of the site having electron transporting property may serve as the site to be coordinated to the surface of the nano-particle 13.

The term “site to be coordinated to the surface of the nano-particle 13” refers to a substituent that coordinates to an atom on the surface of the nano-particle 13, and examples of the substituent include a carboxyl group, a ketone group, a primary amino group, a secondary amino group, a tertiary amino group, a phosphino group, a phosphoroso group, and a thiol group.

The site having electron transporting property is a site having a function of: preventing the particles of the nano-particle light emitting materials 1 of the present invention from agglomerating; or stably dispersing the nano-particle light-emitting materials 1 in a solvent. In addition, the site has a function of injecting an electron injected from a cathode into the nano-particle 13. To be specific, the site is formed of a derivative of a known electron transportable compound to be used in an OLED.

Examples of the electron transportable compound described here include the following compounds.

### Electron Transportable Material

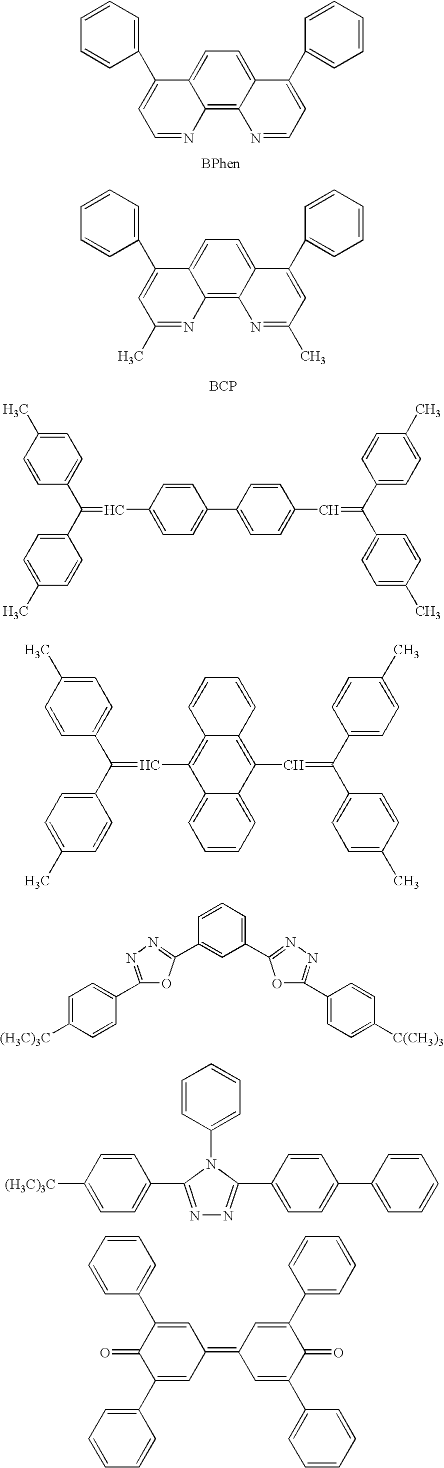

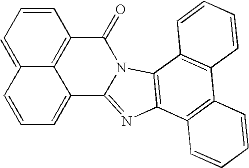

The hole transportable ligands 12 of which the shell portion is formed are each formed of a site to be coordinated to the surface of the nano-particle 13 and a site having hole transporting property. The two sites are not needed to be completely separate, and, for example, part of the site having hole transporting property may serve as the site to be coordinated to the surface of the nano-particle 13.

Specific examples of the site to be coordinated to the surface of the nano-particle 13 described here are similar to those in the case of the electron transportable ligand 11.

The site having hole transporting property is a site having a function of: preventing the particles of the nano-particle light emitting materials 1 of the present invention from agglomerating; or stably dispersing the nano-particle light-emitting materials 1 in a solvent. In addition, the site has a function of injecting a hole injected from an anode into the nano-particle 13. To be specific, the site is formed of a derivative of a known hole transportable compound to be used in an OLED.

Examples of the hole transportable compound described here include the following compounds.

### Hole Transportable Material

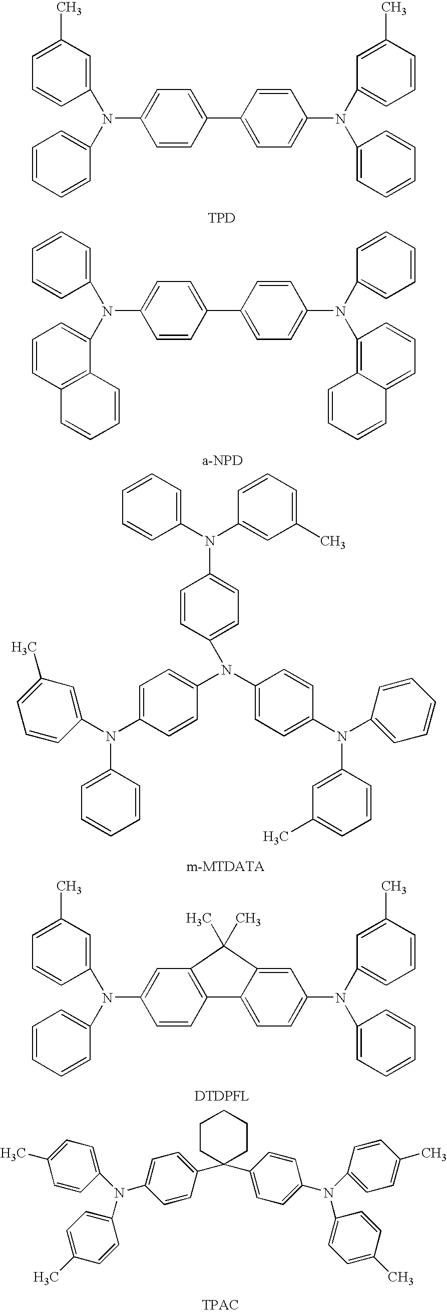

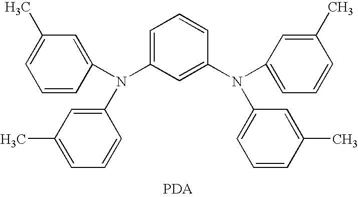

In the nano-particle light emitting material of the present invention, the electron transportable ligands 11 and the hole transportable ligands 12 localized on the surface of the nano-particle 13 may be of one kind, or may be of two or more kinds.

The nano-particle light emitting material of the present invention may contain, on the surface of the nano-particle 13, any other ligand localized on the surface of the nano-particle 13 as well as the electron transportable ligands 11 and the hole transportable ligands 12. The term “other ligand” as used herein refers to a ligand having a function of: preventing the particles of the nano-particle light emitting materials 1 of the present invention from agglomerating; or stably dispersing the nano-particle light-emitting materials 1 in a solvent. Such ligand is, for example, a ligand having a site to be coordinated to the surface of the nano-particle 13 and a site formed of, for example, an aliphatic hydrocarbon group or an aromatic hydrocarbon group, or a substituent obtained by combining the groups. The term “site to be coordinated to the surface of the nano-particle 13” as used herein refers to the same site to be coordinated to the surface of the nano-particle 13 as that of each of the electron transportable ligands 11 and the hole transportable ligands 12.

As shown in FIG. 1, in the nano-particle light emitting material of the present invention, charge is injected into the nano-particle 13 by the hole injection 16 from a hole transportable ligand to the nano-particle and the electron injection 14 from an electron transportable ligand to the nano-particle. In this case, the efficiency with which charge is injected into the nano-particle as a core portion can be improved depending on a combination of the electron transportable ligand and the hole transportable ligand.

To be specific, as shown in FIG. 1, an electron injected from a cathode can be directly injected into the nano-particle 13 while the electron transfer path 15 between ligands is avoided. Similarly, a hole injected from an anode can be directly injected into the nano-particle 13 while the hole transfer path 17 between ligands is avoided.

Conditions under which charge can be efficiently injected into a nano-particle as a core portion as described above will be described below with reference to the drawings.

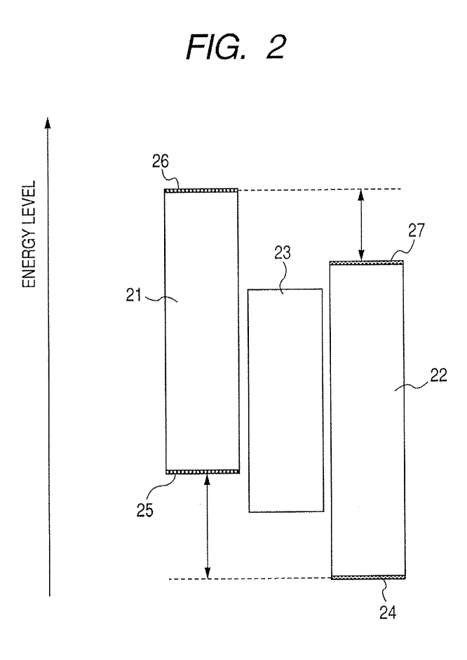

FIG. 2 is an energy level diagram showing a relationship between a ligand and a nano-particle as a condition for an improvement in efficiency with which charge is injected into the nano-particle. In FIG. 2, reference numerals 21 to 23 represent the energy band of a hole transportable ligand, the energy band of the nano-particle, and the energy band of an electron transportable ligand, respectively.

As shown in FIG. 2, the electron transportable ligand and the hole transportable ligand are selected so as to satisfy the following two relationships simultaneously:

(1) the HOMO level 24 of the electron transportable ligand is lower than the HOMO level 25 of the hole transportable ligand; and
(2) the LUMO level 26 of the hole transportable ligand is higher than the LUMO level 27 of the electron transportable ligand.

With such constitution, the efficiency with which charge is injected into the nano-particle is improved. In addition, the establishment of the relationships suppresses the transfer of an electron injected from a cathode between the ligands, and facilitates the injection of the electron into the nano-particle. Similarly, the establishment suppresses the transfer of a hole injected from an anode between the ligands, and facilitates the injection of the hole into the nano-particle.

In addition, in the nano-particle light emitting material of the present invention, the efficiency with which charge injected into the nano-particle as a core portion is confined is improved depending on a combination of the electron transportable ligand and the hole transportable ligand.

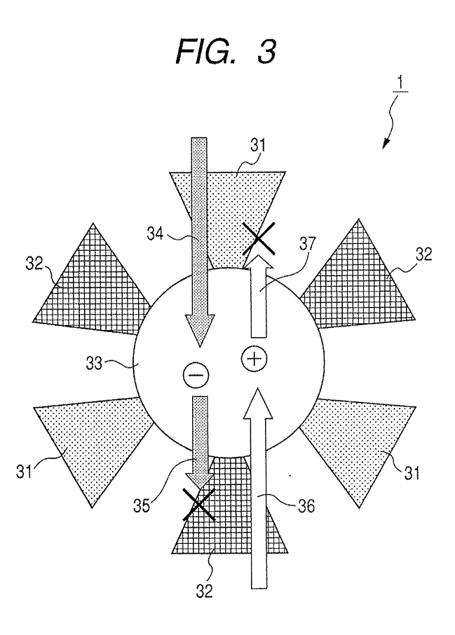

FIG. 3 is a schematic view showing the principle on which a charge confinement effect in the nano-particle light emitting material of the present invention is improved. It should be noted that the electron transportable ligands 31, the hole transportable ligands 32, and the nano-particle 33 shown in FIG. 3 are similar to the electron transportable ligands 11, the hole transportable ligands 12, and the nano-particle 13 shown in FIG. 1, respectively.

As shown in FIG. 3, in the nano-particle light emitting material 1 of the present invention, charge is injected into the nano-particle 33 by the hole injection 36 from a hole transportable ligand to the nano-particle and the electron injection 34 from an electron transportable ligand to the nano-particle. In this case, the electron can be confined in the nano-particle 33 by each of the hole transportable ligands 32 while the movement 35 of the electron from the nano-particle 33 to the outside of the nano-particle is prevented. Similarly, the hole can be confined in the nano-particle 33 by each of the electron transportable ligands 31 while the movement 37 of the hole from the nano-particle 33 to the outside of the nano-particle is prevented.

Conditions under which charge can be efficiently confined into a nano-particle as a core portion as described above will be described below with reference to the drawings.

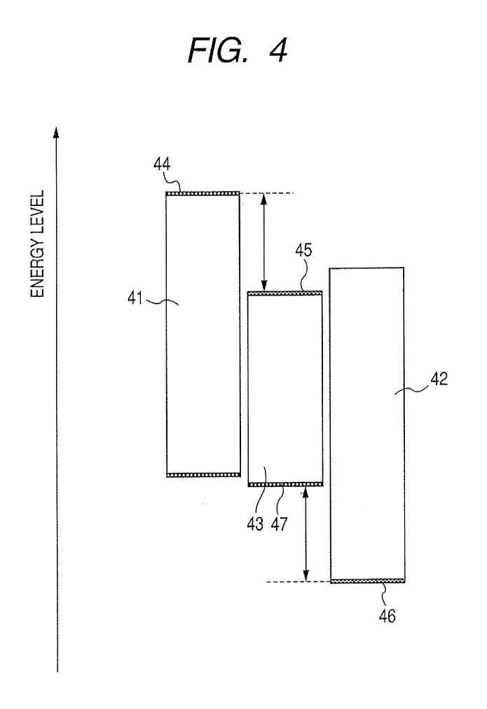

FIG. 4 is an energy level diagram showing a relationship between a ligand and a nano-particle as a condition for an improvement in charge confinement effect. In FIG. 4, reference numerals 41 to 43 represent the energy band of a hole transportable ligand, the energy band of the nano-particle, and the energy band of an electron transportable ligand, respectively.

As shown in FIG. 4, when such a hole transportable ligand that the LUMO level 44 of the hole transportable ligand is higher than the lowest electron level 45 in the conduction band of the nano-particle is selected, an electron injected into the nano-particle is blocked by the hole transportable ligand.

Meanwhile, when such an electron transportable ligand that the HOMO level 46 of the electron transportable ligand is lower than the highest electron level 47 in the valence band of the nano-particle is selected, a hole injected into the nano-particle 33 is blocked by the electron transportable ligand.

The electron and the hole injected into the nano-particle can be efficiently confined in the nano-particle by the hole blocking effect of the electron transportable ligand and the electron blocking effect of the hole transportable ligand described above.

As a result, the probability that the electron and the hole recombine in the nano-particle increases.

As described above, in the nano-particle light emitting material of the present invention, the appropriate selection of an electron transportable ligand and a hole transportable ligand can improve: the efficiency with which charge is injected into a nano-particle; and the efficiency with which charge is confined in the nano-particle and the efficiency with which an electron and a hole recombine in the nano-particle.

Here, the nano-particle light emitting material particularly preferably satisfies all the following two conditions because an improvement in efficiency with which charge is injected into the nano-particle, and improvements in efficiency with which charge is confined in the nano-particle and in efficiency with which an electron and a hole recombine in the nano-particle can be simultaneously achieved:

(1) the LUMO level of the hole transportable ligand is higher than the highest electron level in the valence band of the nano-particle and the LUMO level of the electron transportable ligand; and
(2) the HOMO level of the electron transportable ligand is lower than the lowest electron level in the conduction band of the nano-particle and the HOMO level of the hole transportable ligand.

The nano-particle serving as the core portion of the nano-particle light emitting material of the present invention is more desirably a fine particle having a core-shell structure for the purposes of, for example, improving the durability and weatherability of the material, improving the light emitting efficiency of the material, and controlling the light emitting property of the material. The term “core-shell structure” refers to a laminated structure formed of: a core layer formed of one chemical species; and a shell layer which is formed of another chemical species and with which the core layer is coated. In particular, when one aims to achieve an exciton confinement effect in a semiconductor nano-particle, a shell material having a wider band gap than that of a core material is desirably used. The number of shell layers may be only one, or may be two or more.

Description will be given by taking a fine particle using CdSe in a core layer as an example of the fine particle having a core-shell structure. Although a CdSe nano-particle is a semiconductor nano-particle, and can be used alone as a light emitting material, the nano-particle contains a large number of surface defects, and an exciton confinement effect in the nano-particle is insufficient, so the nano-particle cannot provide sufficient light emitting efficiency. In view of the foregoing, CdSe/ZnS as a nano-particle having the following core-shell structure has been utilized: the core-shell structure is formed of a CdSe nano-particle serving as a core layer, and ZnS having a larger band gap than that of CdSe and serving as a shell layer with which the core layer is coated. The adoption of such core-shell structure has been confirmed to improve the light emitting efficiency of the nano-particle.

Conditions under which an electron or hole confinement effect in the nano-particle having a core-shell structure is improved are determined by, for example, the chemical species of materials of which the core layer and shell layer of the nano-particle are formed, and the thickness of the shell layer.

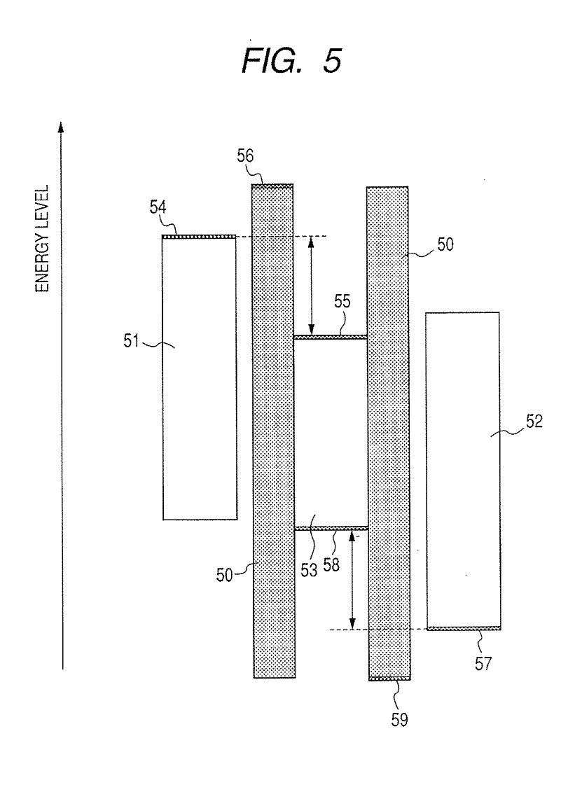

FIG. 5 is an energy level diagram showing a relationship between a ligand and a nano-particle as a condition for an improvement in charge confinement effect when the nano-particle is of a core-shell structure. In FIG. 5, reference numerals 50 to 53 represent the energy band of a shell layer, the energy band of a hole transportable ligand, the energy band of an electron transportable ligand, and the energy band of a core layer, respectively.

In FIG. 5, when the thickness of the shell layer 56 is so small that the layer does not act as a barrier upon injection of charge into the core layer 53, the LUMO level 54 of the hole transportable ligand has only to be higher than the lowest electron level 55 in the conduction band of the core layer. In addition, the HOMO level 57 of the electron transportable ligand has only to be lower than the highest electron level 58 in the valence band of the core layer. With such constitution, charge can be efficiently injected into the nano-particle.

On the other hand, a certain thickness of the shell layer may affect the injection of charge into the core layer 53. In such case, the selection of a ligand in association with a material for the core layer as described above may result in a reduction in charge injecting property. In such case, the LUMO level 54 of the hole transportable ligand has only to be higher than the lowest electron level 56 in the conduction band of the shell layer, or the HOMO level 57 of the electron transportable ligand has only to be lower than the highest electron level 59 in the valence band of the shell layer. Alternatively, the shell layer has only to be reduced in thickness to such an extent that the property with which charge is injected into the core layer is not affected.

The nano-particle light emitting material of the present invention can be produced by coordinating charge transportable ligands to the surface of a nano-particle. An approach to coordinating the charge transportable ligands is not particularly limited, and the charge transportable ligands may be introduced in the stage of synthesizing the nano-particle. Alternatively, the following procedure may be adopted: other ligands are coordinated at the time of the synthesis of the nano-particle, and, thereafter, a ligand substitution operation is performed so that the charge transportable ligands are coordinated to the surface of the nano-particle. In this case, the ligands each of which: is free of a charge transporting function; and has originally coordinated to the surface of the nano-particle may finally remain on and coordinate to the surface of the nano-particle. In addition, in consideration of a process for the ligand substitution, charge transportable ligands of the same kind desirably coordinate to the surface of the nano-particle in such a manner that the ligands are dispersed without being localized.

A component ratio between the electron transportable ligands and the hole transportable ligands to be coordinated to the surface of the nano-particle is set in consideration of various conditions such as: the kind of the nano-particle; the kinds of the ligands; the constitution of an electric field light emitting diode; and the kind of a solvent to be used at the time of the formation of a film.

A weight ratio between the hole transportable ligands and the electron transportable ligands is preferably determined in the range of 95/5 to 5/95 depending on the characteristics of the nano-particle. When it is difficult to inject a hole into the nano-particle, the weight ratio between the hole transportable ligands and the electron transportable ligands preferably falls within the range of 50/50 to 90/10. With such constitution, the efficiency with which a hole is injected into the nano-particle is improved. On the other hand, when it is difficult to inject an electron into the nano-particle, the weight ratio between the hole transportable ligands and the electron transportable ligands preferably falls within the range of 10/90 to 50/50. With such constitution, the efficiency with which an electron is injected into the nano-particle is improved.

Next, an electric field light emitting diode of the present invention will be described.

The electric field light emitting diode of the present invention is formed of: an anode; a cathode; and a layer formed of an organic compound, the layers being interposed between the anode and the cathode, and the layer having at least a light emitting layer, and is characterized in that the light emitting layer contains at least one kind of the nano-particle light emitting material of the present invention.

Hereinafter, the electric field light emitting diode of the present invention will be described in detail with reference to the drawings.

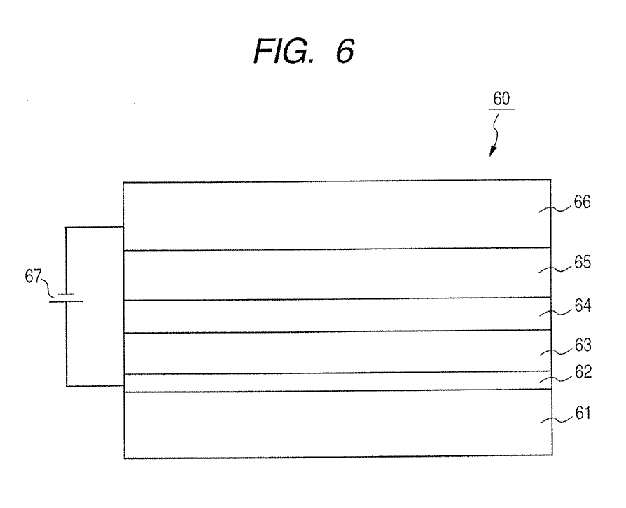

FIG. 6 is a sectional view showing an embodiment of the electric field light emitting diode of the present invention. The electric field light emitting diode 60 shown in FIG. 6 is obtained by sequentially laminating the substrate 61, the anode 62, the hole transporting layer 63, the light emitting layer 64, the electron transporting layer 65, and the cathode 66. In addition, the electric field light emitting diode 60 shown in FIG. 6 is connected to the power source 67.

The electric field light emitting diode of the present invention is not limited to the embodiment. For example, a hole injecting layer may be provided between the anode 62 and the hole transporting layer 63, or an electron injecting layer may be provided between the electron transporting layer 65 and the cathode 66. Alternatively, a layer for blocking an electron may be provided between the hole transporting layer 63 and the light emitting layer 64, or a layer for blocking a hole may be provided between the light emitting layer 64 and the electron transporting layer 65.

The electric field light emitting diode of the present invention can have high efficiency by introducing the nano-particle light emitting material of the present invention into the light emitting layer 64. Here, the light emitting layer 64 may be formed only of the nano-particle light emitting material of the present invention. Alternatively, the light emitting layer 64 may be such layer as described below: the layer is formed of a host and a guest, and uses the nano-particle light emitting material of the present invention as the guest.

Next, an ink composition of the present invention will be described.

The ink composition of the present invention contains at least one kind of the nano-particle light emitting material of the present invention.

The nano-particle light emitting material of the present invention can be used in the ink composition because the material has good solubility in an organic solvent. In addition, the use of the ink composition of the present invention enables the production of the layers each formed of an organic compound, the layers constituting the electric field light emitting diode of the present invention, in particular, the light emitting layer 64 by an application method, whereby a large-area diode can be easily produced at a relatively low cost.

As a solvent dissolving the nano-particle light emitting material of the present invention, toluene, xylene, mesitylene, chloroform, dioxane, tetralin, n-dodecylbenzene, methyl naphthalene, tetrahydrofuran, diglyme, 1,2-dichlorobenzene, 1,2-dichloropropane, and the like are mentioned.

In addition, the ink composition of the present invention may contain a compound serving as an additive as well as the nano-particle light emitting material of the present invention. Examples of the compound serving as an additive include the known hole transportable material, the known light emitting material, and the known electron transportable material described above.

The concentration of the nano-particle light emitting material of the present invention in the ink composition is preferably 0.05 wt % or more to 20 wt % or less, or more preferably 0.1 wt % or more to 5 wt % or less with respect to the entirety of the composition.

A display apparatus such as a display can be formed by: providing the electric field light emitting diode of the present invention with a driver circuit; and arraying the resultant in a sheet shape. A display apparatus including the electric field light emitting diode of the present invention is excellent in color reproducibility, durability, and power saving property.

### Example 1

### Synthesis of Nano-Particle Light Emitting Material

1 ml of methanol was added to 1 ml of a dispersion of CdSe nano-particles each having a surface coated with TOPO (manufactured by Evident Technologies, Inc., average core particle diameter about 4 nm, nano-particle concentration 10 mg/ml) in toluene, and the mixture was stirred. Next, the mixture was centrifuged at 12,000 rpm for 15 minutes, whereby a precipitate was produced. Next, the supernatant was removed, and the precipitated CdSe nano-particles were dried. After that, 1 ml of chloroform was added to the nano-particles, whereby a solution of the CdSe nano-particles in chloroform was obtained.

Next, 6 mg of an α-NPD derivative represented by the following formula and serving as a hole transportable ligand, and 4 mg of BPhen serving as an electron transportable ligand were added to the solution, and the mixture was stirred under a nitrogen atmosphere at room temperature for 12 hours while light was shielded so that a ligand substitution operation was performed. After that, 1 ml of methanol was added to the mixture so that a precipitate was produced, and the supernatant was removed, whereby a powder was obtained. The operation was repeated several times so that the powder was purified. 1 ml of chloroform was added to the final precipitate, whereby a transparent solution of nano-particle light emitting materials in chloroform was obtained.

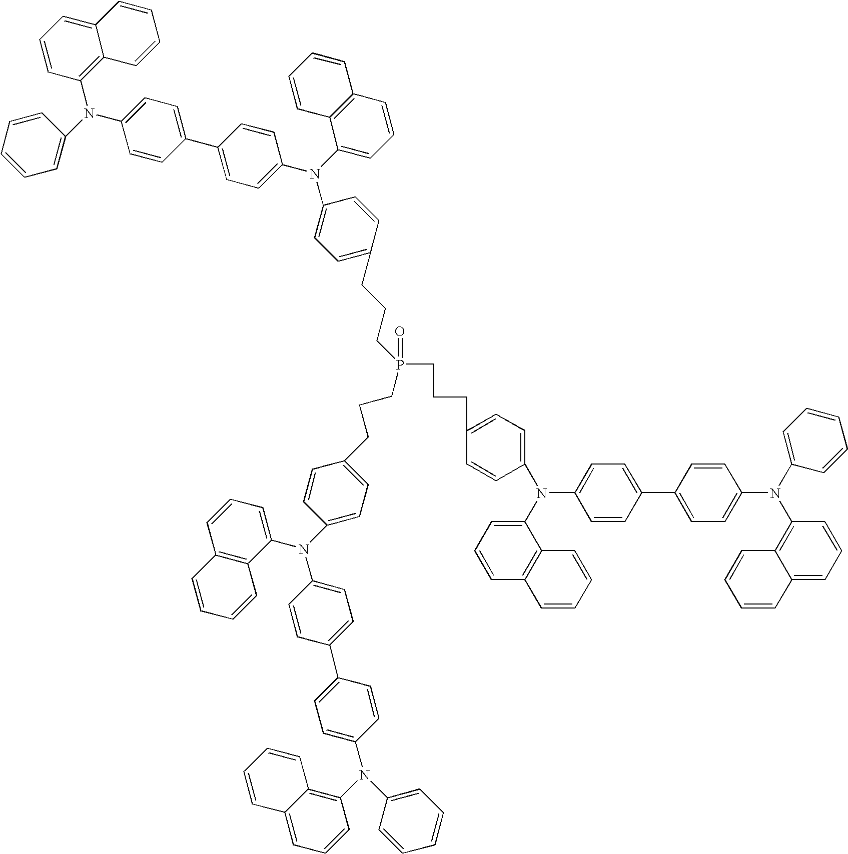

Through the foregoing operation, a dispersion of the nano-particle light emitting materials in chloroform each obtained by coordinating, to the surface of a CdSe nano-particle, the α-NPD derivative serving as a hole transportable ligand and BPhen serving as an electron transportable ligand was obtained. Here, the α-NPD derivative had a HOMO level of −5.5 eV and a LUMO level of −2.5 eV, and BPhen had a HOMO level of −6.4 eV and a LUMO level of −2.9 eV. Accordingly, those ligands satisfied the conditions shown in FIG. 2. It should be noted that the HOMO level of each material was calculated from the work function of the material, and the LUMO level of the material was calculated from a band gap estimated from the work function of the material and an absorption edge of the light absorption spectrum of the material.

### Example 2

Nano-particle light emitting materials were synthesized under the same conditions as those of Example 1 except that the electron transportable ligand in Example 1 was changed to BCP. In this case, BCP had a HOMO level of −6.7 eV and a LUMO level of −3.0 eV. In addition, each CdSe nano-particle had a highest electron level in its valence band of −6.5 eV and a lowest electron level in its conduction band of −4.4 eV. Accordingly, the charge transportable ligands on the surfaces of the nano-particles of this example satisfied the conditions shown in FIGS. 2 and 4.

### Example 3

Nano-particle light emitting materials were synthesized under the same conditions as those of Example 2 except that CdSe/ZnS core-shell-structured nano-particles each having a surface coated with TOPO (manufactured by Evident Technologies, Inc., average core particle diameter about 5 nm, nano-particle concentration 10 mg/ml) were used as nano-particles in Example 2.

In this case, each CdSe/ZnS nano-particle had a highest electron level in the valence band of its core layer of −6.5 eV and a lowest electron level in the conduction band of the core layer of −4.4 eV. Meanwhile, the nano-particle had a highest electron level in the valence band of its shell layer of −7.5 eV and a lowest electron level in the conduction band of the shell layer of −3.4 eV. Accordingly, the charge transportable ligands on the surfaces of the nano-particles of this example satisfied the conditions shown in FIG. 5.

### Comparative Example 1

Nano-particle light emitting materials were synthesized under the same conditions as those of Example 1 except that: CdSe/ZnS core-shell-structured nano-particles each having a surface coated with TOPO (manufactured by Evident Technologies, Inc., average core particle diameter about 5 nm, nano-particle concentration 10 mg/ml) were used as nano-particles; and only BPhen was used as a ligand.

### Example 4

### Production of Electric Field Light Emitting Diode

The electric field light emitting diode shown in FIG. 6 was produced by using the nano-particle light emitting materials obtained in Example 1. In this case, TPD, Alq₃, and Al were used in the hole transporting layer, the electron transporting layer, and the back electrode, respectively. In addition, the diode was produced in conformance with Nature, 2002, Vol. 420, p. 800. First, under a nitrogen atmosphere, a chloroform solution containing the nano-particle light emitting materials and TPD was applied onto a washed ITO substrate. Next, the electron transporting layer and the back electrode were formed in the stated order by a vacuum vapor deposition method. Finally, nitrogen was sealed in the resultant, whereby the field effect light emitting diode was obtained. The application of a voltage to the produced electric field light emitting diode caused the diode to emit red light originating from the nano-particles. The electric field light emitting diode was further evaluated. The results of the evaluation showed that the diode started to emit light at a voltage of 8 V, and had an external quantum efficiency of 0.5% and a light emitting peak wavelength of 620 nm.

The foregoing confirmed that the nano-particle light emitting material of the present invention had improved property with which charge was injected into a nano-particle as compared to that of a conventional nano-particle light emitting material.

### Example 5

An electric field light emitting diode was produced in the same manner as in Example 4 except that the nano-particle light emitting materials obtained in Example 2 were used. The application of a voltage to the produced electric field light emitting diode caused the diode to emit red light originating from the nano-particles. The electric field light emitting diode was further evaluated. The results of the evaluation showed that the diode started to emit light at a voltage of 8 V, and had an external quantum efficiency of 0.8% and a light emitting peak wavelength of 620 nm.

The foregoing confirmed that the nano-particle light emitting material of the present invention had improved effect with which charge was confined into a nano-particle as compared to that of a conventional nano-particle light emitting material.

### Comparative Example 2

An electric field light emitting diode was produced in the same manner as in Example 4 except that CdSe nano-particles each having a surface coated with TOPO (manufactured by Evident Technologies, Inc., average core particle diameter about 4 nm, nano-particle concentration 10 mg/ml) were used as nano-particle light emitting materials. The application of a voltage to the produced electric field light emitting diode caused the diode to emit red light originating from the nano-particles. The electric field light emitting diode was further evaluated. The results of the evaluation showed that the diode started to emit light at a voltage of 10 V, and had an external quantum efficiency of 0.1% and a light emitting peak wavelength of 620 nm.

### Example 6

An electric field light emitting diode was produced in the same manner as in Example 4 except that the nano-particle light emitting materials obtained in Example 3 were used. The application of a voltage to the produced electric field light emitting diode caused the diode to emit red light originating from the nano-particles. The electric field light emitting diode was further evaluated. The results of the evaluation showed that the diode started to emit light at a voltage of 4 V, and had an external quantum efficiency of 3% and a light emitting peak wavelength of 620 nm.

The foregoing confirmed that an electric field light emitting diode having a nano-particle light emitting material using a core-shell type nano-particle excellent in light emitting efficiency in the core portion of the material exerted the effect of the present invention.

### Comparative Example 3

An electric field light emitting diode was produced in the same manner as in Example 4 except that CdSe/ZnS core-shell type nano-particles (manufactured by Evident Technologies, Inc., average core particle diameter about 5 nm, nano-particle concentration 10 mg/ml) were used as nano-particle light emitting materials. The application of a voltage to the produced electric field light emitting diode caused the diode to emit red light originating from the nano-particles. The electric field light emitting diode was further evaluated. The results of the evaluation showed that the diode started to emit light at a voltage of 7.5 V, and had an external quantum efficiency of 1% and a light emitting peak wavelength of 620 nm.

### Comparative Example 4

An electric field light emitting diode was produced in the same manner as in Example 4 except that the nano-particle light emitting materials synthesized in Comparative Example 1 were used. The application of a voltage to the produced electric field light emitting diode caused the diode to emit red light originating from the nano-particles. The electric field light emitting diode was further evaluated. The results of the evaluation showed that the diode started to emit light at a voltage of 10 V, and had an external quantum efficiency of 0.1% and a light emitting peak wavelength of 620 nm.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-049149, filed Feb. 28, 2007, which is hereby incorporated by reference herein in its entirety.

What is claimed is:

1. A nano-particle light emitting material, comprising:
a core portion formed of a nano-particle; and
a shell portion formed of at least two kinds of ligands localized on a surface of the core portion,
wherein at least one kind of the ligands comprises a hole transportable ligand, and at least one kind of the ligands comprises an electron transportable ligand.

2. The nano-particle light emitting material according to claim 1, wherein the nano-particle comprises a fine particle having a core-shell structure.

3. The nano-particle light emitting material according to claim 1, wherein a HOMO level of the electron transportable ligand is lower than a HOMO level of the hole transportable ligand, and a LUMO level of the hole transportable ligand is higher than a LUMO level of the electron transportable ligand.

4. The nano-particle light emitting material according to claim 1, wherein the HOMO level of the electron transportable ligand is lower than a highest electron level in a valence band of the nano-particle.

5. The nano-particle light emitting material according to claim 1, wherein the LUMO level of the hole transportable ligand is higher than a lowest electron level in a conduction band of the nano-particle.

6. An electric field light emitting diode, comprising:
an anode;
a cathode; and
a layer formed of an organic compound, the layer being interposed between the anode and the cathode, and the layer having at least a light emitting layer,
wherein the light emitting layer contains at least one kind of the nano-particle light emitting material according to claim 1.

7. An ink composition comprising at least one kind of the nano-particle light emitting material according to claim 1.

8. A display apparatus comprising the electric field light emitting diode according to claim 6.
